(19) United States
(12) Patent Application Publication
(10) Pub. No.: US 2010/0229162 A1
(43) Pub. Date: Sep. 9, 2010

(54) COMPILING APPARATUS, COMPILING METHOD, AND PROGRAM PRODUCT

(75) Inventors: Ryuji HADA, Kanagawa (JP); Takashi Miyamori, Kanagawa (JP); Keiri Nakanishi, Kanagawa (JP); Masato Sumiyoshi, Tokyo (JP); Takahisa Wada, Kanagawa (JP); Yasuki Tanabe, Tokyo (JP); Katsuyuki Kimura, Kanagawa (JP); Shunichi Ishiwata, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/559,962

(22) Filed: Sep. 15, 2009

(30) Foreign Application Priority Data
Mar. 3, 2009 (JP) 2009-049114

(51) Int. Cl. G06F 9/45; G06F 9/30

(52) U.S. Cl. 717/156; 712/201; 712/E09.016

(57) ABSTRACT

A compiling apparatus includes an instruction-sequence-hierarchy-graph generating unit that generates an instruction sequence hierarchy graph by arraying unit graphs, to each of which a data path realized by a plurality of microinstructions included in one instruction sequence is to be allocated and in each of which function units included in a target processor are a node and a data line between the function units is an edge, to correspond to an execution order of a plurality of instruction sequences and by connecting arrayed unit graphs with an edge corresponding to a hardware path capable of establishing a data path across the instruction sequences; a data path allocating unit that allocates a data path to each of the unit graphs constituting the instruction sequence hierarchy graph; and an object program output unit that generates an instruction sequence group based on the data path allocated to the instruction sequence hierarchy graph.

### CROSS-REFERENCE TO RELATED APPLICATIONS

This application is based upon and claims the benefit of priority from the prior Japanese Patent Application No. 2009-049114, filed on Mar. 3, 2009; the entire contents of which are incorporated herein by reference.

### BACKGROUND OF THE INVENTION

1. Field of the Invention

The present invention relates to a compiling apparatus, a compiling method, and a program product.

2. Description of the Related Art

Conventionally, as a typical method of executing data reception and transmission between instruction sequences each consisting of a plurality of microinstructions in an arithmetic processing unit (processor) that executes instruction sequences concurrently, a method is known to configure the processor so that a register is accessible from any operation unit for input and output. Hereinafter, such configuration is called a centralized register system, and such register is called a centralized register. If the centralized register is employed, a large amount of hardware cost is needed for the processor. This is because, since data reference and data update need to be executed simultaneously between all processing units executed in parallel and register files, data buses proportional to the parallelism, i.e., the number of instructions that can be processed simultaneously and a memory having a plurality of ports are required.

On the other hand, for example, Japanese Patent Application Laid-open No. 2003-99249 discloses a configuration having a register (distributed register) that limits an accessible operation unit to reduce a hardware cost of the port or the bus, which is called a distributed register system. This technology enables distribution of register access by a predetermined data bus with respect to a distributed register. However, if a data path cannot be programmably allocated to the data bus, the configuration of the distributed register system is inferior to that of the centralized register system in terms of versatility. Moreover, a method of realizing a data path by a compiling apparatus (compiler) is not described in Japanese Patent Application Laid-open No. 2003-99249.

A pipeline register can also be considered as one type of a distributed register. There is a method of executing data reception and transmission between instruction sequences via the pipeline register. With this method, data reception and transmission between continuous instructions is realized by bypassing a resultant value of a preceding instruction to be a following input via the pipeline register based on a result of analysis of data dependency. However, the dependence analysis and the bypass control are realized by hardware.

For reducing an amount of hardware for the bypass control, a processing apparatus capable of specifying data to be bypassed in an instruction operand is disclosed in Japanese Patent Application Laid-open No. H11-65844. With this technology, it is considered that data dependence analysis is executed by a compiler or the like and data that needs to be automatically bypassed is extracted to be embedded in an instruction code. However, a method thereof and a compiling method thereof are not described.

### BRIEF SUMMARY OF THE INVENTION

A compiling apparatus according to an embodiment of the present invention comprises:

an instruction-sequence-hierarchy-graph generating unit that generates an instruction sequence hierarchy graph by arraying unit graphs, to each of which a data path realized by a plurality of microinstructions included in one instruction sequence is to be allocated and in each of which function units are a node and a data line between the function units is an edge, to correspond to an execution order of a plurality of instruction sequences and by connecting arrayed unit graphs with an edge corresponding to hardware path;

a data path allocating unit that allocates a data path realizing a data flow structure of a source program to each of the unit graphs constituting the instruction sequence hierarchy graph; and

an object program output unit that generates an instruction sequence group based on the data path allocated to the instruction sequence hierarchy graph.

A compiling method according to an embodiment of the present invention comprises:

generating an instruction sequence hierarchy graph by arraying unit graphs, to each of which a data path realized by a plurality of microinstructions included in one instruction sequence is to be allocated and in each of which function units are a node and a data line between the function units is an edge, to correspond to an execution order of a plurality of instruction sequences and by connecting arrayed unit graphs with an edge corresponding to the hardware path;

allocating a data path realizing a data flow structure of a source program to each of the unit graphs constituting the instruction sequence hierarchy graph; and

generating an instruction sequence group based on the data path allocated to the instruction sequence hierarchy graph.

A program product according to an embodiment of the present invention causes the computer to execute:

generating an instruction sequence hierarchy graph by arraying unit graphs, to each of which a data path realized by a plurality of microinstructions included in one instruction sequence is to be allocated and in each of which function units are a node and a data line between the function units is an edge, to correspond to an execution order of a plurality of instruction sequences and by connecting arrayed unit graphs with an edge corresponding to the hardware path;

allocating a data path realizing a data flow structure of a source program to each of the unit graphs constituting the instruction sequence hierarchy graph; and

generating an instruction sequence group based on the data path allocated to the instruction sequence hierarchy graph.

### BRIEF DESCRIPTION OF THE DRAWINGS

FIG. 1 is a schematic diagram of an example of a target processor according to a present embodiment of the present invention;

FIG. 2 is a schematic diagram of an example of an instruction hierarchy graph (IHG);

FIG. 3 is a block diagram for explaining a configuration according to the present embodiment of the present invention;

FIG. 4 is a block diagram for explaining a hardware configuration according to the present embodiment of the present invention;

FIG. 5 is a flowchart for explaining an operation according to the present embodiment of the present invention;

FIG. 6 is a schematic diagram for explaining an example of an architecture diagram;

FIG. 7 is a schematic diagram for explaining an example of a data flow graph (DFG);

FIG. 8 is a flowchart for explaining an operation according to the present embodiment of the present invention;

FIG. 9 is a schematic diagram for explaining a generated IHG;

FIG. 10 is a schematic diagram for explaining information in a table format about a specific node; and

FIG. 11 is a schematic diagram for explaining an example of a data path search algorithm.

### DETAILED DESCRIPTION OF THE INVENTION

Exemplary embodiments of a compiling apparatus, a compiling method, and a program product according to the present invention will be explained below in detail with reference to the accompanying drawings. The present invention is not limited to the following embodiments.

A compiling apparatus and a compiling program according to a present embodiment generate an object program with a processor including at least one of the following characteristics as a target processor.

A processor including a distributed register as a data reception/transmission unit between instruction sequences.

A processor including a bypass as the data reception/transmission unit between instruction sequences.

A processor capable of data reception/transmission even between operation units that are cascade-connected.

A processor that includes at least one of the above characteristics and a processor that includes at least one of the above characteristics and a centralized register.

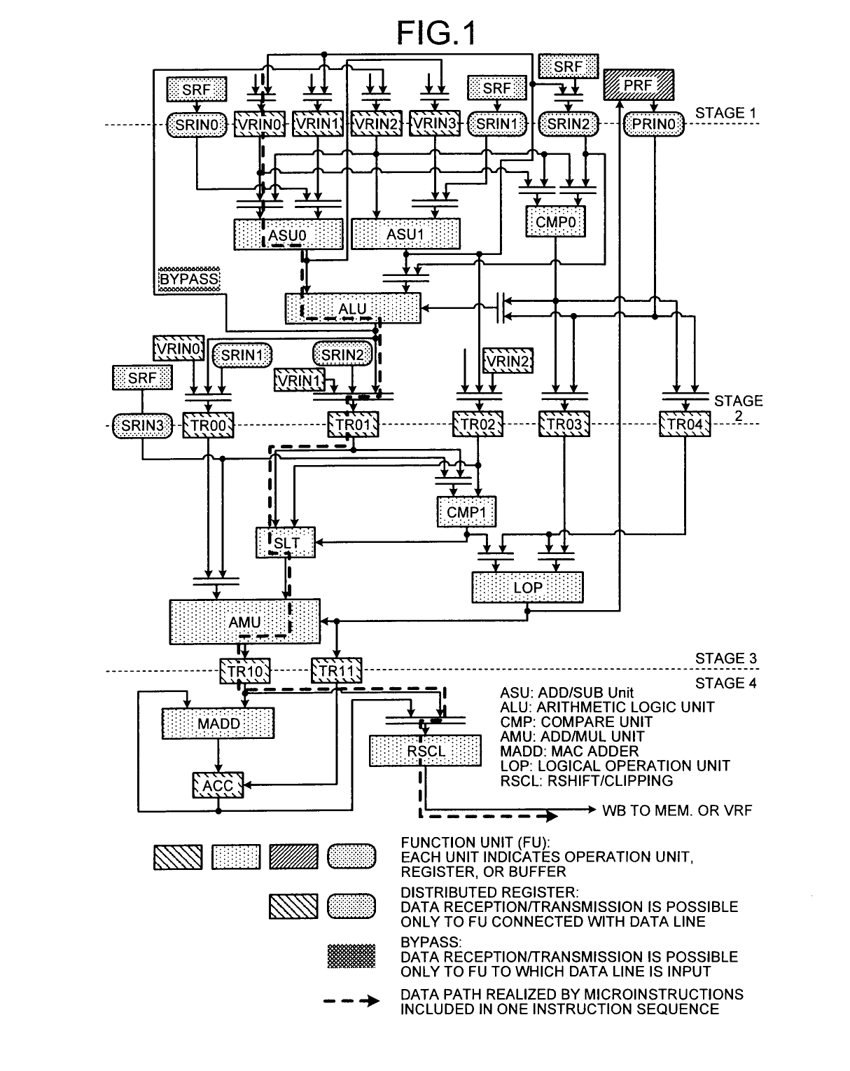

FIG. 1 is a schematic diagram of an example of a target processor according to the present embodiment of the present invention. Specifically, FIG. 1 is a microarchitecture diagram explicitly illustrating data paths of the target processor. The processor can perform pipeline processing on an instruction sequence that consists of a plurality of microinstructions. The pipeline has four stages. The stage of the pipeline processing consists of a stage 1 in which input of data is received from centralized registers SRF and PRF to pipeline registers SRIN0 to SRIN2, VRIN0 to VRIN3, and PRIN0, a stage 2 in which a first calculation is performed on the received data and a calculation result is stored in pipeline registers TR00 to TR04, a third stage in which a second calculation is performed on the data stored in the pipeline registers TR00 to TR04 and a calculation result is stored in pipeline registers TR10 and TR11, and a fourth stage in which predetermined processing is executed on the data stored in the pipeline registers TR10 and TR11 and resultant data is output to a VRF that is a memory or a centralized register. In the present embodiment, a pipeline register is regarded as a distributed register. Moreover, a memory is regarded as a centralized register in the following explanation.

Each function unit (FU) such as an operation unit, a buffer, and a register of a target processor needs to be enabled to specify a function and input and output destination by a microinstruction. Each function unit has a different function such as one having only a calculation function or one having a data path control function. In a target processor, a function unit of input and output destination needs to be specified by a microinstruction to realize a data path in an instruction sequence and between instruction sequences.

For example, in the processor shown in FIG. 1, when an ALU is caused to calculate addition of output data from an ASU0 and output data from an ASU1, a microinstruction “ADD ALU ASU0 ASU1” is used. When storing output of the ALU in the TR01, a microinstruction “SET TR01 ALU” is used. In this manner, input and output destination of each function unit is specified by each microinstruction included in an instruction sequence to sequentially establish a data path, thereby enabling to establish data paths as shown in FIG. 1 by one instruction sequence.

When data stored in the TR01 as a distributed register is handed to the next instruction sequence, a microinstruction “Hold TR01” is used. With this microinstruction, data stored in the TR01 remains in the TR01 without change, so that data reception/transmission to a microinstruction of the next instruction sequence can be made via the TR01. The processor shown in FIG. 1 includes a bypass that can input an output result of the ALU that operates at the stage 2 to the VRIN 2 as input data at the stage 1. Data that is input to the VRIN 2 via the bypass is handled at the stage 1 of the next instruction sequence. For example, a data path using the bypass can be established by using a microinstruction “Set VRIN2 ALU”. The bypassed data can be used by a microinstruction of the next instruction sequence. In this manner, with the corporation of a hardware path such as a distributed register and a bypass and software as an instruction sequence that includes microinstructions specifying input and output destination and uses the hardware path, a data path across instruction sequences can be realized on the hardware path.

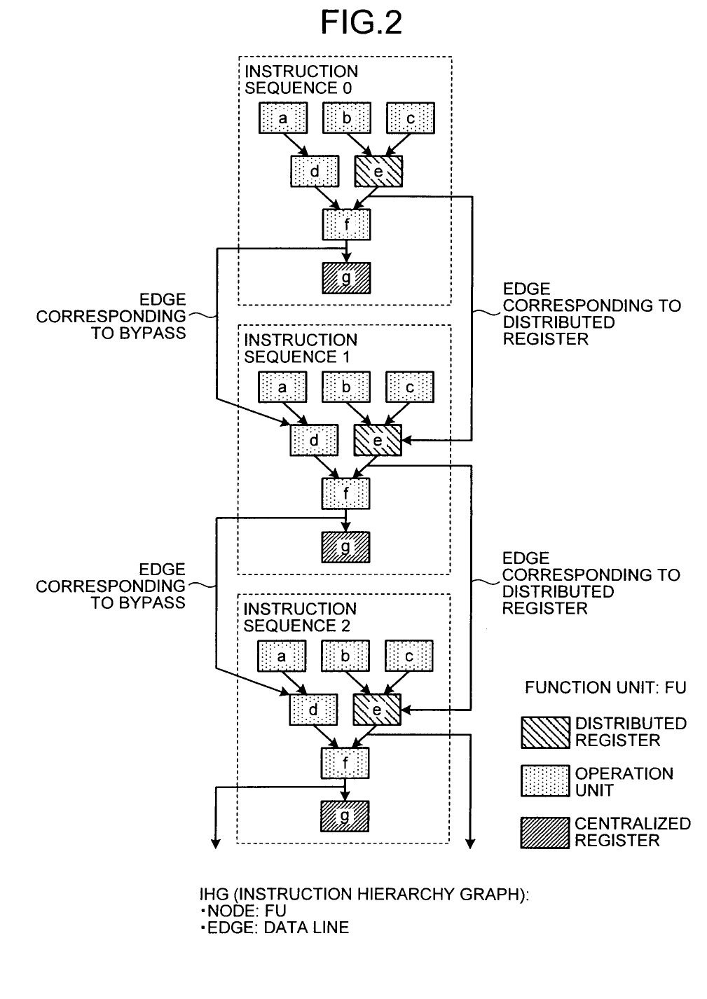

The present embodiment of the present invention is mainly characterized in that a graph is generated that can easily execute allocation of data paths in an instruction sequence or between instruction sequences to generate an instruction sequence group (object program) that establishes a data path across instruction sequences in a target processor having the above characteristics. FIG. 2 is a schematic diagram for explaining the graph.

As shown in FIG. 2, the graph is configured to prepare a graph in which an FU is a node and a data line is an edge for each instruction sequence. An individual graph (unit graph) is a graph in which data paths by microinstructions included in one instruction sequence are allocated, and a plurality of unit graphs is arrayed in order corresponding to an execution order of instruction sequences. In this case, a graph of an instruction sequence of a later execution order is arrayed at a lower position. An edge is a directed edge with a node of a data transmission source as a source node and a node of a data transmission destination as a destination node. An individual graph for each instruction sequence is similar to a microarchitecture diagram indicating data paths; however is different from the microarchitecture diagram in the following points. That is, in the individual graph for each instruction sequence, when a processor includes a bypass, a source node and a destination node via the bypass are not connected by an edge in a graph of the same instruction sequence. A source node in each instruction sequence is connected to a destination node in the next instruction sequence by an edge. Moreover, when a processor includes a distributed register, a distributed register in each instruction sequence as a source is connected to the same distributed register belonging to the next instruction sequence as a destination node by an edge. In other words, unit graphs are connected by an edge corresponding to a hardware path. FIG. 2 is a graph of a processor in which a node f and a node d have a bypass network and a node e is a distributed register. As shown in FIG. 2, the node f of an instruction sequence 0 is connected to the node d of an instruction sequence 1 by an edge, and the node f of the instruction sequence 1 is connected to the node d of the instruction sequence 2 by an edge. Moreover, the node e of the instruction sequence 0 is connected to the node e of the instruction sequence 1 by an edge, and the node e of the instruction sequence 1 is connected to the node e of the instruction sequence 2 by an edge. In other words, individual graphs are connected with each other by edges corresponding to a hardware path across instruction sequences, so that data paths, i.e., data or an instruction can be easily allocated to each FU. A graph group consisting of unit graphs for respective instruction sequences is referred to as an instruction hierarchy graph.

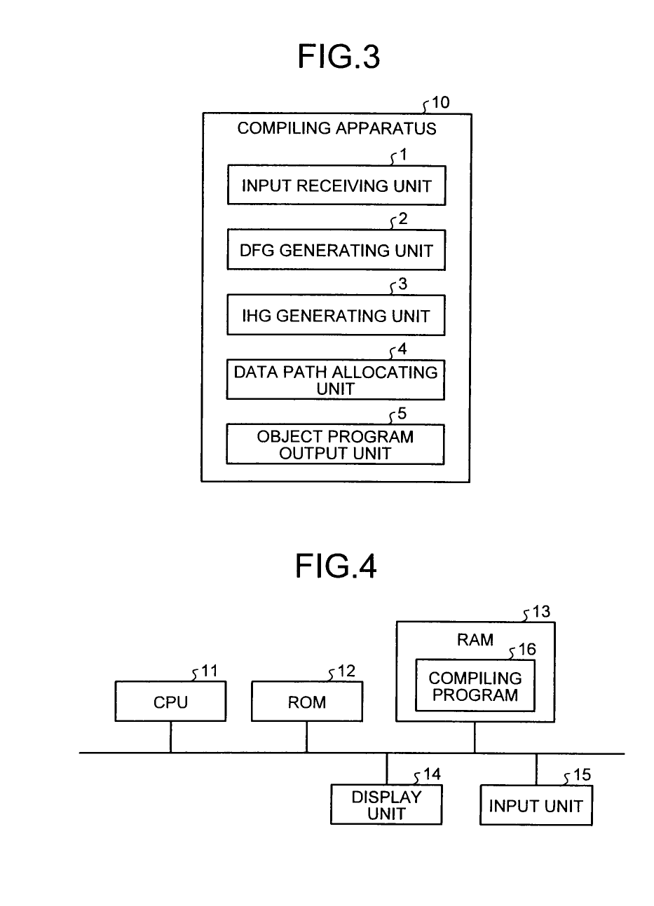

FIG. 3 is a block diagram for explaining a functional configuration of a compiling apparatus 10. The compiling apparatus 10 has a configuration to realize the above characteristics. Specifically, as shown in FIG. 3, the compiling apparatus 10 includes an input receiving unit 1, a data flow graph (DFG) generating unit 2, an instruction hierarchy graph (IHG) generating unit 3, a data path allocating unit 4, and an object program output unit 5. The input receiving unit 1 receives input of a source program and architecture information of a processor, the DFG generating unit 2 analyzes the source program received by the input receiving unit 1 and generates a DFG, the IHG generating unit 3 generates the IHG based on the architecture information received by the input receiving unit 1, the data path allocating unit 4 allocates data paths for realizing a data flow of the DFG generated by the DFG generating unit 2 to the IHG generated by the IHG generating unit 3, and the object program output unit 5 generates an object program based on the data paths allocated to the IHG and outputs it.

The architecture information input to the input receiving unit 1 can be any information so long as it is information from which an FU, a data line, and a direction of a data flow flowing in the data line can be recognized. For example, the architecture information can be an architecture diagram indicating data paths as shown in FIG. 1.

FIG. 4 is a schematic diagram for explaining a hardware configuration of the compiling apparatus 10. The compiling apparatus 10 has a computer configuration including a central processing unit (CPU) 11, a read only memory (ROM) 12, a random access memory (RAM) 13, a display unit 14, and an input unit 15. The CPU 11, the ROM 12, the RAM 13, the display unit 14, and the input unit 15 are connected with each other via a bus line.

The CPU 11 executes a compiling program 16 as a computer program compiling a source program. The display unit 14 is a display device such as a liquid crystal monitor, and displays output information for a user such as an operation screen based on an instruction from the CPU 11. The input unit 15 includes a mouse and a keyboard, from which a user inputs an operation for the compiling apparatus 10. The operation information input to the input unit 15 is sent to the CPU 11.

The compiling program 16 is stored in the ROM 12 and is loaded onto the RAM 13 via a bus line. The CPU 11 executes the compiling program 16 loaded on the RAM 13. Specifically, in the compiling apparatus 10, the CPU 11 reads out the compiling program 16 from the ROM 12, loads the compiling program 16 onto a program storing area in the RAM 13, and executes various processing, in accordance with an instruction input from the input unit 15 by a designer. The source program or the architecture information is input from an external storage device or the like. The CPU 11 executes various processing based on the source program or the architecture information input from the external storage device or the like and temporarily stores data such as the DFG and the IHG generated in the various processing in a data storing area formed in the RAM 13. The CPU 11 outputs the generated object program to the program storing area in the RAM 13, the external storage device, and the like. The compiling program 16 can be stored in a storage device such as a disk or can be loaded onto a storage device such as a disk.

The compiling program 16 executed in the compiling apparatus 10 includes the above units (the input receiving unit 1, the DFG generating unit 2, the IHG generating unit 3, the data path allocating unit 4, and the object program output unit 5). Each of the units is generated on a main storage device by loading them onto the main storage device.

The compiling program 16 executed in the compiling apparatus 10 can be provided in such a way that the compiling program 16 is stored in a computer connected to a network such as the Internet and is downloaded via the network. The compiling program 16 executed in the compiling apparatus 10 can also be provided or distributed via the network such as the Internet. Alternatively, the compiling program 16 can be incorporated in a ROM or the like in advance and provided to the compiling apparatus 10.

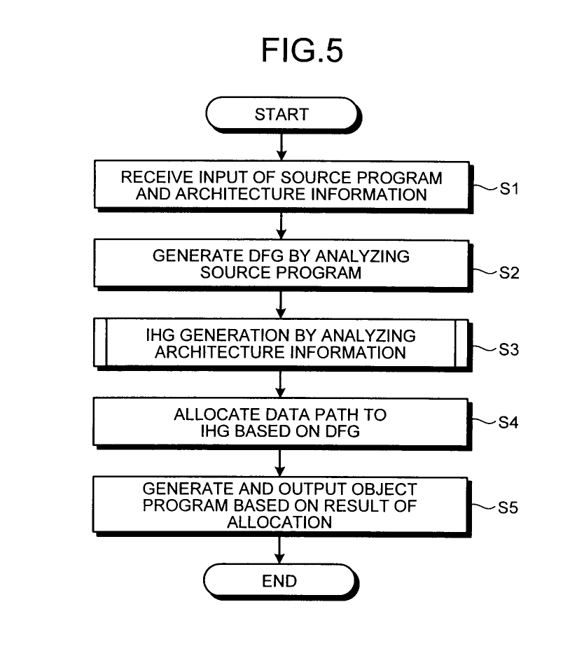

Next, an operation of the compiling apparatus 10 is explained. FIG. 5 is a flowchart of the operation of the compiling apparatus 10.

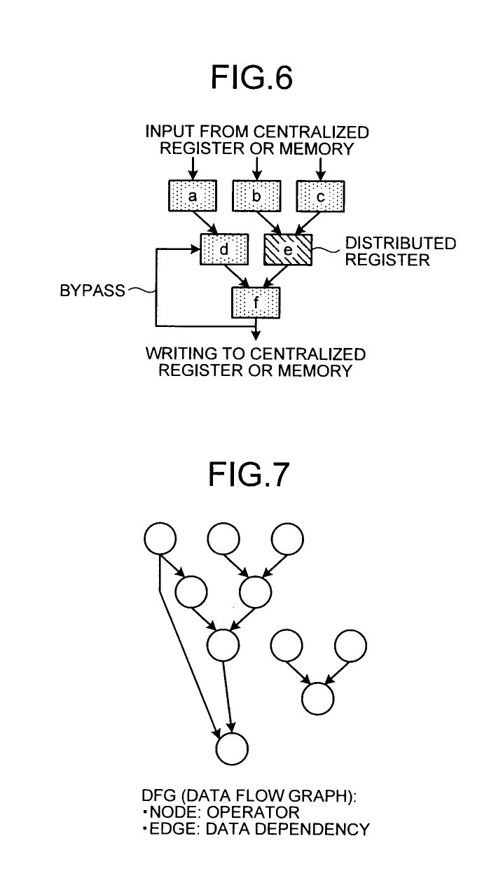

In FIG. 5, first, the input receiving unit 1 receives input of a source program and architecture information from an external storage device or the like (S1). An architecture diagram shown in FIG. 6 is input as the architecture information.

In the architecture diagram shown in FIG. 6, data is input to operation units a, b, and c from a centralized register or a memory. The operation units a, b, and c each perform a predetermined calculation. Output data from the operation unit a is sent to an operation unit d, and output data from the operation units b and c is stored in a distributed register e. A bypass is provided between the operation unit d and an operation unit f of a subsequent stage, so that the operation unit d can perform calculation by using output data from the operation unit a and/or data that is bypassed from the operation unit f and output data to the operation unit f. The operation unit f can perform calculation by using data from the operation unit d and/or the distributed register e and output data to a centralized register, a memory, or the operation unit d.

The DFG generating unit 2 analyzes the source program received by the input receiving unit 1 and generates a DFG (S2). FIG. 7 is a schematic diagram for explaining an example of a DFG generated by the DFG generating unit 2. A DFG is a graph with an operator as a node and a data dependency as a directed edge.

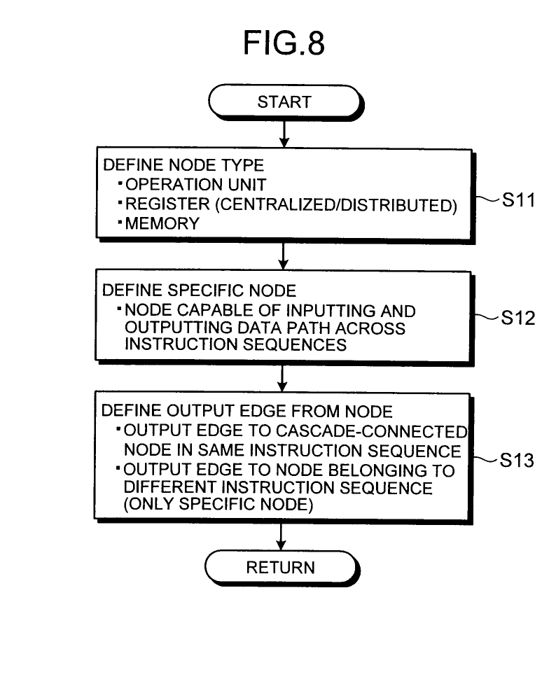

Next, the IHG generating unit 3 generates an IHG based on the architecture information received by the input receiving unit 1 (S3). FIG. 8 is a flowchart for explaining the operation at S3 in further detail.

In FIG. 8, first, the IHG generating unit 3 defines a node (S11). The node represents an FU, i.e., an operation unit, a concentrated/distributed register, and a memory. In an example shown in FIG. 6, data is supplied to the operation units a, b, c, d, and f, the distributed register e, and a centralized register and a memory that supply data to the operation units a, b, and c and are supplied with data from the operation unit f are the node.

Next, the IHG generating unit 3 defines a specific node (S12). The specific node represents a node that can input and output a data path across instruction sequences, i.e., an FU of a transmission source (bypass source) capable of transmitting data via a distributed register or a bypass. In an example shown in FIG. 6, a node e corresponding to the distributed register e and a node f corresponding to the operation unit f of a bypass source are the specific node.

Next, the IHG generating unit 3 prepares a plurality of node groups defined at S11 and S12, determines each set as an allocation destination of data paths realized by one instruction sequence, i.e., as a unit graph, and defines an output edge for each node belonging to each unit graph (S13). In the case of a node (cascade-connected node) other than a specific node, the IHG generating unit 3 defines an output edge in a unit graph of the same instruction sequence based on a data line and a direction of a data flow described in the architecture information. In the case of a node of a distributed register of a specific node, the IHG generating unit 3 defines an output edge with a node of the distributed register as a source and the same node belonging to a unit graph of the next instruction sequence as a destination. In the case of a node of a bypass source of a specific node, the IHG generating unit 3 defines an output edge with a node of the bypass source as a source and a node of a bypass destination belonging to a unit graph of an instruction sequence next to an instruction sequence that the node belongs to.

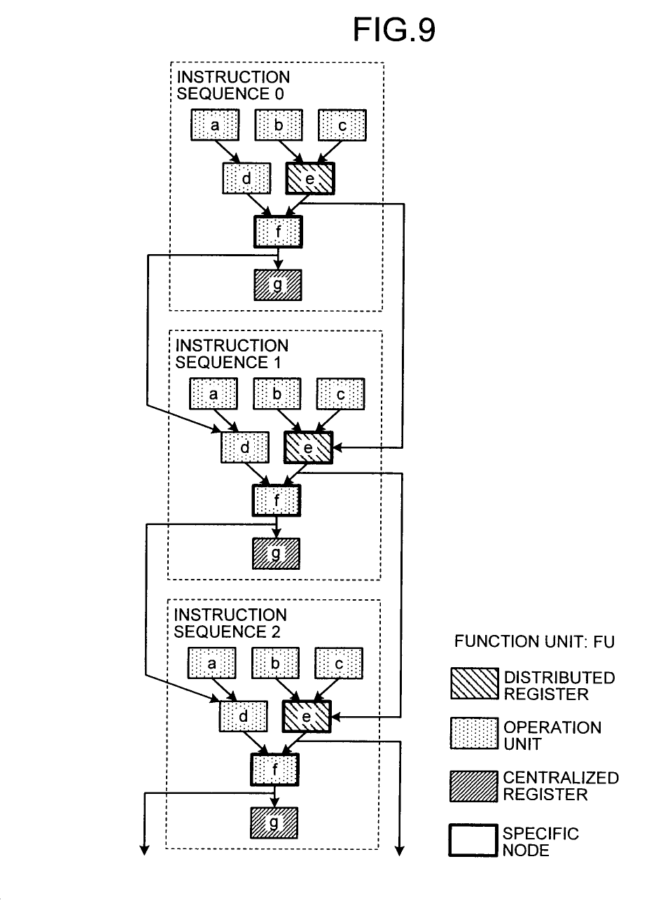

With the above operation, an IHG shown in FIG. 9 is generated. A node drawn with a thick frame is a specific node, and a node g is a centralized register. Data output to the node g can be input to nodes a, b, and c; however, input and output to the node g takes time of a few cycles. Therefore, normally, an output edge needs to be drawn in which the node g is a source and the nodes a, b, and c of an instruction sequence after a few instruction sequences are destinations; however, an edge with the node g as a source is omitted to avoid complication.

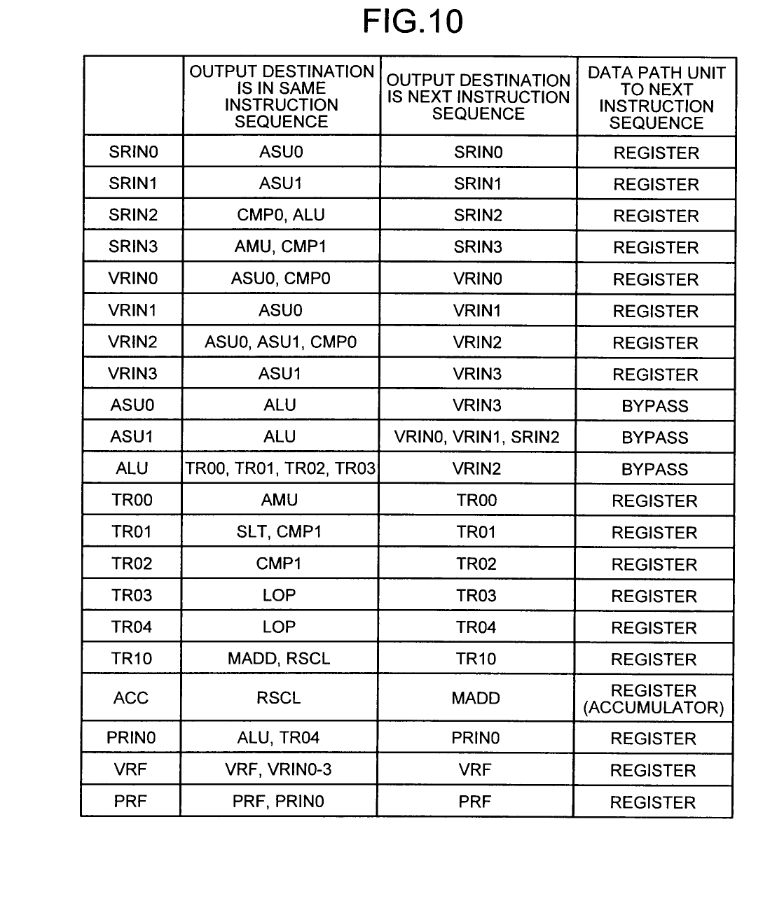

In the present embodiment, a graph as shown in FIG. 9 can be displayed as information displayed on the display unit 14; however, the compiling apparatus 10 can manage an IHG with information in a table format defining a source and a destination as source data for displaying the graph. For example, FIG. 10 is a schematic diagram of information in a table format in which a specific node and an output edge concerning the specific node in the processor shown in FIG. 1 are defined. For example, in the information concerning the SRIN0 as a distributed register described at the uppermost row in FIG. 10, with the SRIN0 as a source, an output edge with the ASU0 of the same instruction sequence as a destination and an output edge with the SRIN0 belonging to the next instruction sequence as a destination are defined. In the information concerning the ALU at the tenth row from the uppermost row, an output edge with the ALU as a source and the TR00, the TR01, the TR02, and the TR03 in the same instruction sequence as a destination, and an output edge with the ALU as a bypass source and the VRIN2 belonging to the next instruction sequence as a bypass destination are defined.

Subsequent to S3 in FIG. 5, the data path allocating unit 4 allocates the data paths for realizing a data flow of the DFG generated by the DFG generating unit 2 to the IHG generated by the IHG generating unit 3 (S4). An allocating method is not specifically limited. For example, if S4 is executed with a process of allocating each operator and data based on a function of an FU and a process of determining allocation if a data path is established as a result of a search for an allocated operator and a data path of data, the data path searching process can be executed by an algorithm explained below as an example.

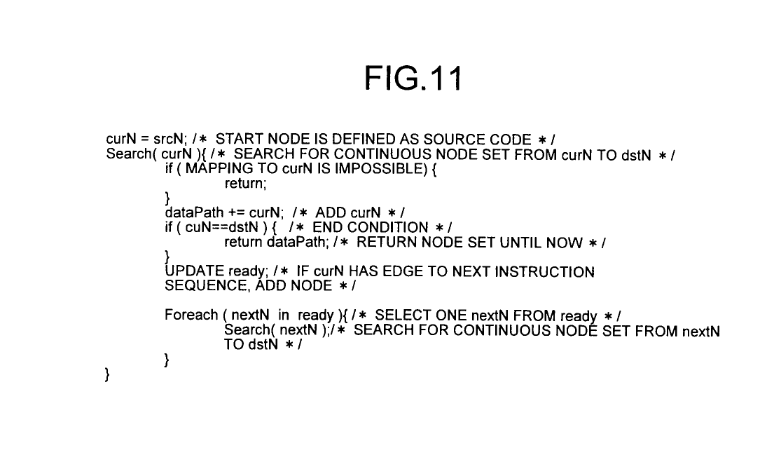

FIG. 11 is a schematic diagram explaining an example of an algorithm for the data path searching. In the algorithm shown in FIG. 11, “srcN” indicates a node to be a source. “dstN” indicates a node to be a destination. “curN” indicates a currently focused node. “ready” indicates a set of input destination nodes of an output edge of “curN”. “nextN” is a node selected from “ready”, and an input edge to “nextN” is an output edge of “curN”. “dataPath” indicates a set of traced nodes. As shown in FIG. 11, starting from a state of “curN”=“srcN”, the next “curN” is determined based on an output edge with “curN” as a source until reaching a state equal to a state of “curN”=“dstN”. In searching the graph, it is needed to go through the specific node defined at S12 for transmitting to a different instruction sequence. However, in an IHG, a graph is prepared for each instruction sequence and an output edge across instruction sequences is defined, so that even a data path across instruction sequences can be easily detected. In other words, a data path across instruction sequences can be easily generated.

The object program output unit 5 generates an instruction sequence group, i.e., an object program, based on microinstructions allocated to the IHG, and outputs it to an external storage device or the like. Because one instruction sequence is generated from each unit graph, a plurality of instruction sequences is generated from an IHG including a plurality of unit graphs.

According to the present embodiment, for a processor that includes a hardware path, such as a distributed register and a bypass, realizing a data path across instruction sequences, a graph is defined in which a destination of a data path from an operation unit and a register concerning a distributed register and a bypass is set to a node in an instruction sequence or a node out of the instruction sequence capable of data passing. A data path is established between nodes in the defined graph. Thus, it is possible to generate an object program that receives and transmits data across instruction sequences.

In the above explanation, a depth first search is explained as an example of a method of searching a data path using an IHG; however, it is not limited thereto. For example, a binary tree search or a node-number first search can be employed as the method of searching a data path.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A compiling apparatus that generates an instruction sequence group with a processor, which includes a plurality of function units including a register and an operation unit, executes an instruction sequence including a plurality of microinstructions specifying function units of data input and output destination with respect to the function units, and includes a hardware path capable of establishing a data path across instruction sequences, as a target processor, the compiling apparatus comprising:
an instruction-sequence-hierarchy⁻graph generating unit that generates an instruction sequence hierarchy graph by arraying unit graphs, to each of which a data path realized by a plurality of microinstructions included in one instruction sequence is to be allocated and in each of which the function units are a node and a data line between the function units is an edge, to correspond to an execution order of a plurality of instruction sequences and by connecting arrayed unit graphs with an edge corresponding to the hardware path;
a data path allocating unit that allocates a data path realizing a data flow structure of a source program to each of the unit graphs constituting the instruction sequence hierarchy graph; and
an object program output unit that generates an instruction sequence group based on the data path allocated to the instruction sequence hierarchy graph.

2. The compiling apparatus according to claim 1, wherein the hardware path is at least one of a bypass and a register.

3. The compiling apparatus according to claim 1, further comprising a data flow graph generating unit that analyzes input source program and generates a data flow graph in which the data flow structure of the source program is described.

4. A compiling method for generating an instruction sequence group with a processor, which includes a plurality of function units including a register and an operation unit, executes an instruction sequence including a plurality of microinstructions specifying function units of data input and output destination with respect to the function units, and includes a hardware path capable of establishing a data path across instruction sequences, as a target processor, the compiling method comprising:
generating an instruction sequence hierarchy graph by arraying unit graphs, to each of which a data path realized by a plurality of microinstructions included in one instruction sequence is to be allocated and in each of which the function units are a node and a data line between the function units is an edge, to correspond to an execution order of a plurality of instruction sequences and by connecting arrayed unit graphs with an edge corresponding to the hardware path;
allocating a data path realizing a data flow structure of a source program to each of the unit graphs constituting the instruction sequence hierarchy graph; and
generating an instruction sequence group based on the data path allocated to the instruction sequence hierarchy graph.

5. The compiling method according to claim 4, wherein the hardware path is at least one of a bypass and a register.

6. The compiling method according to claim 4, further comprising:
analyzing input source program; and
generating a data flow graph in which the data flow structure of the source program is described.

7. A program product for generating an instruction sequence group with a processor, which includes a plurality of function units including a register and an operation unit, executes an instruction sequence including a plurality of microinstructions specifying function units of data input and output destination with respect to the function units, and includes a hardware path capable of establishing a data path across instruction sequences, as a target processor, which when executed by a computer, causes the computer to execute:
generating an instruction sequence hierarchy graph by arraying unit graphs, to each of which a data path realized by a plurality of microinstructions included in one instruction sequence is to be allocated and in each of which the function units are a node and a data line between the function units is an edge, to correspond to an execution order of a plurality of instruction sequences and by connecting arrayed unit graphs with an edge corresponding to the hardware path;
allocating a data path realizing a data flow structure of a source program to each of the unit graphs constituting the instruction sequence hierarchy graph; and
generating an instruction sequence group based on the data path allocated to the instruction sequence hierarchy graph.

8. The program product according to claim 7, wherein the hardware path is at least one of a bypass and a register.

9. The program product according to claim 7, further causing the computer to execute:
analyzing input source program; and
generating a data flow graph in which the data flow structure of the source program is described.
